(19) United States
(12) Patent Application Publication
(10) Pub. No.: US 2005/0058185 A1
(43) Pub. Date: Mar. 17, 2005

(54) Integrated circuit for code acquisition

(75) Inventor: Philip Mattos, Ruardean Woodside (GB)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics Limited, Bristol (GB)

(21) Appl. No.: 10/815,167

(22) Filed: Mar. 31, 2004

(30) Foreign Application Priority Data
Mar. 31, 2003 (GB) 0307442.4

(51) Int. Cl. H04B 1/707

(52) U.S. Cl. 375/150

(57) ABSTRACT

A method of acquiring a received broadcast signal that includes mixing the signal with a local frequency and digitizing the same to produce a received digitized signal, correlating the received digitized signal with a local version of a repeated code in the signal using a clock derived coherently from a master clock source and again for a second time period that is separated by a separation period for producing first and second results, and combining the first and second correlation results by comparing the location of correlation peaks to reject peaks not appearing at the same position in both the first and second correlation results.

### FIELD OF THE INVENTION

The present invention relates to the acquisition and tracking of broadcast pseudo random codes, in particular codes transmitted as part of a GPS signal.

### BACKGROUND OF THE INVENTION

The Global Position System (GPS) is a well-known system, which uses broadcast pseudo random codes to allow receivers to determine time differences, and hence relative positions, between a transmitter and receiver. The transmitters are satellites orbiting the earth in known orbit paths whose position at any given time is accurately known. Using received signals from four such satellites, a receiver can unambiguously determine its position using trigonometry to accuracy dependent upon the repetition rate of the code, accuracy of components and other factors, such as the atmosphere and multipath reflections.

To increase accuracy, more than the minimum of four reference transmitters is usually tracked. There are around 24 satellites available for tracking in the GPS system, of which 8 are specified to be “visible” by a receiver at any given time. In fact, GPS receivers typically include 12 channels to allow up to 12 satellites to be tracked at once.

GPS satellites transmit two L-Band signals, which can be used for positioning purposes. The reasoning behind transmitting using two different frequencies is so that errors introduced by ionospheric refraction can be eliminated.

The signals, which are generated from a standard frequency of 10.23 MHz, are L1 at 1575.42 MHz and L2 at 1227.60 MHz and are often called the carriers.

The frequencies are generated from the fundamental satellite clock frequency of fₒ=1.023 MHz.

| Signal | Frequency (MHz) | Wavelength (cm) |
|---|---|---|
| L1 | 1540f₀ = 1575.42 | ^{˜}19 |
| L2 | 1200f₀ = 1227.60 | ^{˜}24 |

Since the carriers are pure sinusoids, they cannot be used easily for instantaneous positioning purposes and therefore two binary codes are modulated onto them: the C/A (coarse acquisition) code and P (precise) code.

Also it is necessary to know the coordinates of the satellites and this information is sent within the broadcast data message, which is also modulated onto the carriers.

The coarse/acquisition (CA) code was so named as it was originally designed as a coarse position measurement signal on its own, or as an acquisition code to assist in looking onto the phase of the precise code. However, the CA code is now used generally both for acquisition and for position tracking, and so will be referred to simply as the CA code herein.

The C/A code is a pseudo random (PN) binary code (states of 0 and 1) consisting of 1,023 elements, or chips that repeats itself every millisecond. The term pseudo random is used since the code is apparently random although it has been generated by means of a known process, hence the repeatability.

Due to the chipping rate (the rate at which each chip is modulated onto the carrier) of 1.023 Mbps, the chip length corresponds to approximately 300 m in length and due to the code length, the ambiguity is approximately 300 km—i.e. the complete C/A code pattern repeats itself every 300 km between the receiver and the satellite.

The code is generated by means of a linear feedback register which is a hardware device representing a mathematical PRN algorithm.

The sequences that are used are known as Gold codes, which have particularly good autocorrelation and cross correlation properties. The cross correlation properties of the gold codes are such that the correlation function between two different sequences is low—this is how GPS receivers distinguish between signals transmitted from different satellites.

A representation of the CA code, data message bits and the resultant signal spectrum is shown in FIG. 1. As can be seen, the thermal noise level is higher than the actual signal level. In fact, the thermal noise is around −110 dB per MHz whereas the signal itself is around −130 dB. To extract the CA code from the noise, use is made of the fact that the CA code is a known sequence and correlation is performed. The function performed is to integrate the received signal with a locally generated version of the CA code, as follows:

$$\begin{matrix}{\int }_{0}^{20 ms} ( \begin{matrix}signal + \\ noise\end{matrix} ) \times CA code = {\int }_{0}^{20 ms} ( \begin{matrix}carrier \times data \times \\ CA code\end{matrix} ) \times \\ CA code + {\int }_{0}^{20 ms} ( noise ) \times \\ CA code \\ = {\int }_{0}^{20 ms} ( carrier \times data \times 1 ) + ( 0 )\end{matrix}$$

As can be seen, the integration of white noise over the integration period is substantially zero, whereas the integration of the CA code×CA code is 1.

The result of the integration is that the noise component does not increase in signal level, but that (carrier×data component CA code is increased by 20,000=+43 dB. The signal to noise ratio is now:
−130 dB (signal) +110 dB (noise) +43 dB (integration gain)=+23 dB

The signal energy thereby becomes distinguishable from the noise. Indoor operation of GPS or Galileo requires reception of signals attenuated by at least 20 dB from their outdoor equivalents. A nominal GPS signal is −130 dBm, but outdoors can be up to −120 dBm due to antenna gain, and over-spec satellites. This would be 42 dB Cno, 52 dB Cno respectively in the signal to noise ratio report of the receiver.

A weak GPS signal outside, might, due to poor low-angle response from an antenna, be down to 30 dB Cno, without considering obstructions. However indoors, through 20 dB of wall, the typical 42 dB Cno may become 22 dB, and with compromised antennas, 15 dB C/No is the desired target.

The first satellite is the hardest to find, because the GPS receiver has only coarse estimates of frequency and time, so must search many kilohertz in the frequency domain, and the full 1 millisecond code phase. Once the first satellite is found, the others can be referenced from it, with much more accurate estimates of frequency and time.

Increasing the sensitivity by 20 dB means integrating for 100 times longer, however that is achieved. It often cannot be achieved directly, because as the coherent integration period is extended, so the bandwidth of the channel is narrowed, resulting in many more searches being required, and eventually the stability of the reference oscillator becomes a limiting factor, as the signal appears to wander from one frequency bin to another even before acquisition is completed. This spreads its energy, preventing further gain. Additionally, in C/A code GPS, the BPSK data modulation prevents effective integration beyond 20 milliseconds.

A traditional receiver integrates for 1 millisecond. To integrate for 100 millisecond would mean 100 times as many searches, and each would only cover 10 Hz bandwidth, approaching the limit for stability. Without parallelism, searching the 2046 time domain possibilities would be increased from 2 seconds of real time, to 2×100×100, clearly at 20,000 seconds, this is totally impractical.

Even with ×1000 parallelism, it would take 20 seconds, while the target time is more like 3 seconds.

So in addition to parallelism, achieved either in time (faster clocks) or space (more hardware) domain, we have appreciated that something must be done to lessen the cost of extending coherent integration.

When correlating to acquire the signal the time and hence code phase of the incoming signal is an unknown. It is necessary, therefore, to compare 2×1,023=2,046 acquisition samples of the CA code signal for every possible relative position of the incoming and locally generated CA codes, with an integration period of typically 1 millisecond. It thus takes around 2 seconds to acquire the first satellite using one channel. Thereafter the position of the sequence is known and tracking requires only two correlations, rather than 2046, to maintain the tracking position within a few nanoseconds window of the early and late measurements.

It is also necessary to search all possible frequency bins. This is because the satellite motion causes a Doppler shift of around ±4 or 5 KHz and other factors such as local oscillator error introduce frequency uncertainty. Typically, there are 40 frequency bins to search to cover the total uncertainty.

### SUMMARY OF THE INVENTION

We have appreciated the need to increase accuracy of acquisition, particularly to avoid off-frequency cross-correlation. The invention is defined in the claims to which reference is now directed.

A circuit embodying the invention performs correlations at two or more separated time periods and combines the results to reduce the risk of cross-correlation. The techniques to distinguish correct correlations from cross-correlations include determining whether the correlation peaks appear at the same positions in the two or more correlations. Cross correlations will produce correlation peaks at different positions in the separated correlation results. This is because the signal from different satellites will suffer differing amounts of Doppler shift resulting in differing rates of change of code time.

The embodying circuit determines which correlation code phase positions from one correlation result to compare with the next by determining which positions produce correlation amplitudes that are N times a mean value, where N is typically between 2 and 4. These are defined as peaks. The value N can be determined and reconfigured in advance, or calculated in use and is chosen so that the ratio of code positions to peaks is around 5 percent.

Other criteria include defining peaks as those which must have higher correlation values than both immediate neighbour code phase positions. This eliminates code phase positions which would otherwise be considered as potential acquisition positions, but which in reality are likely to be the result of energy from the centre correlation position between the two either side.

A further criteria is that, to be considered a peak, the energy in the correlation result from a first one of the one or more correlations must be derived from a signal at the same frequency as a correlation result from a second one of the one or more correlations. This prevents the erroneous consideration of correlation results which actually derive from different satellites whose Doppler shifts happen to result in coincidence of above mean correlation values at the same code phase positions.

In the circuit embodying the invention, a single clock source is used to derive the frequency used to mix down the received signal and to drive the acquisition correlations. This clock coherence ensures that a correlation performed for a given received frequency produces correlation results in the same code phase bins over a time period longer than the typical correlation period of order milliseconds. Correlation results deriving from off frequency signals (other satellites with differing Doppler shift) will change code phase position over longer time periods because the correlation clock will not exactly match the code rate of the analysed signal.

The criteria stated above may be implemented in hardware of software and both are within the scope of the invention.

### BRIEF DESCRIPTION OF THE FIGURES

An embodiment of the invention will now be described by way of example only and with reference to the accompanying figures, in which:

FIG. 1: is a representation of a repeated CA code as used in the present invention and its signal spectrum;

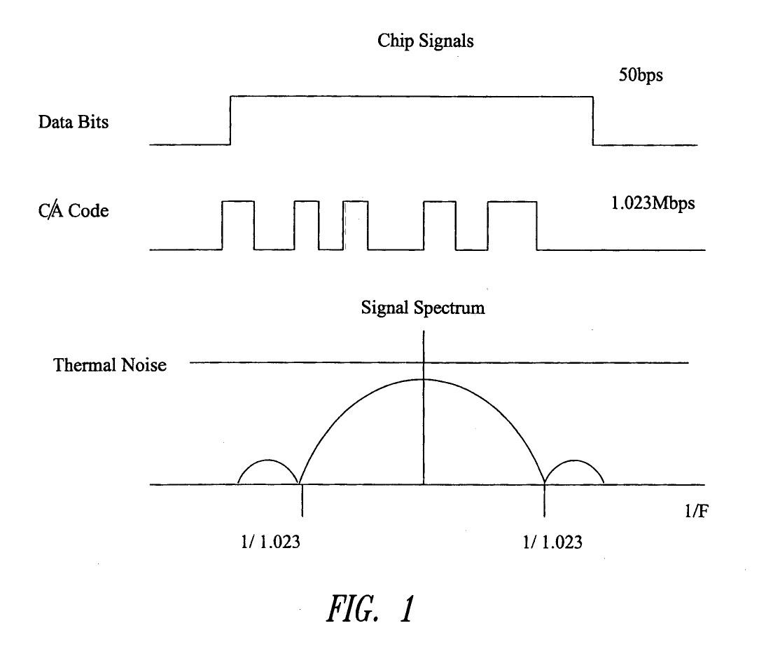

FIG. 2: shows the radio section of a GPS receiver embodying the invention;

FIG. 3: shows the functional components of a digital signal processor (DSP) as arranged for tracking in a GPS receiver embodying the invention;

FIG. 4: shows the functional components of a digital signal processor (DSP) as arranged for acquisition in a GPS receiver embodying the invention;

FIG. 5: shows integration results for an integration period of 1.6 seconds;

FIG. 6: shows the main steps of an algorithm embodying the invention;

FIG. 7: shows two integration periods and a separation period;

FIG. 8: shows the algorithm of FIG. 6 in greater detail;

FIG. 9: shows integration results for differing time periods;

FIG. 10: shows integration results for 480 ms; and

FIG. 11: shows the effect of using the algorithm of FIGS. 6 and 8.

### DESCRIPTION OF A PREFERRED EMBODIMENT

The embodiment of the invention is a GPS receiver for GPS signal acquisition and tracking, but modified to include additional functionality, which is operable to reduce the risk of cross-correlation. The embodiment comprises three main elements: a radio unit which derives a mixing frequency from a clock source and a digital clock from the same clock source; a digital signal processor (DSP) which receives the digital clock and performs correlations; and an algorithm which can be implemented in hardware of software in the DSP.

The receiver is operable in two modes, an acquisition mode and tracking mode. It is in the acquisition mode that the main benefit of the invention is realised in reducing off frequency cross correlations.

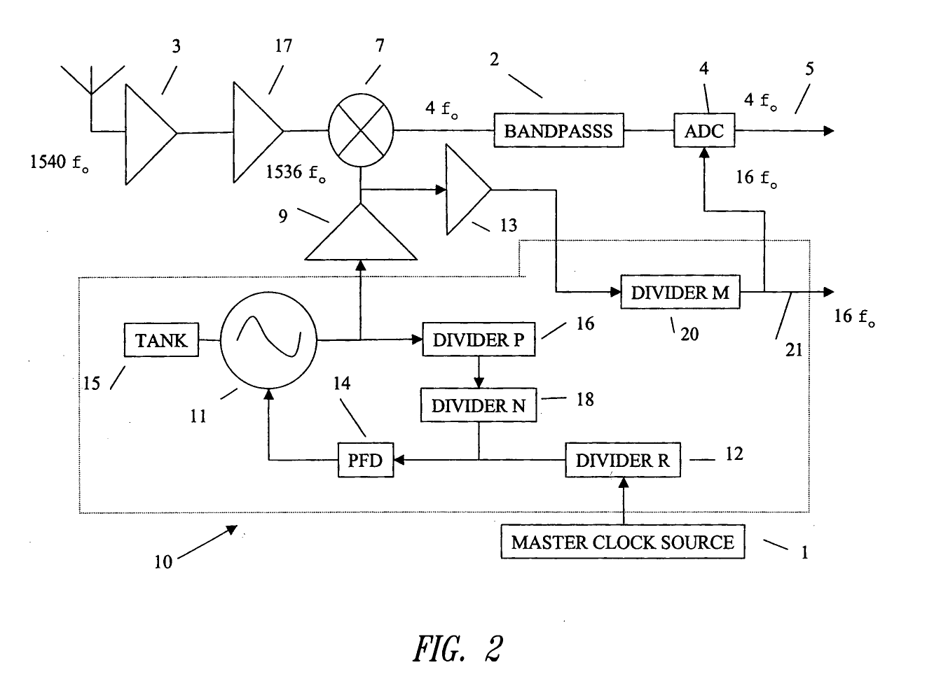

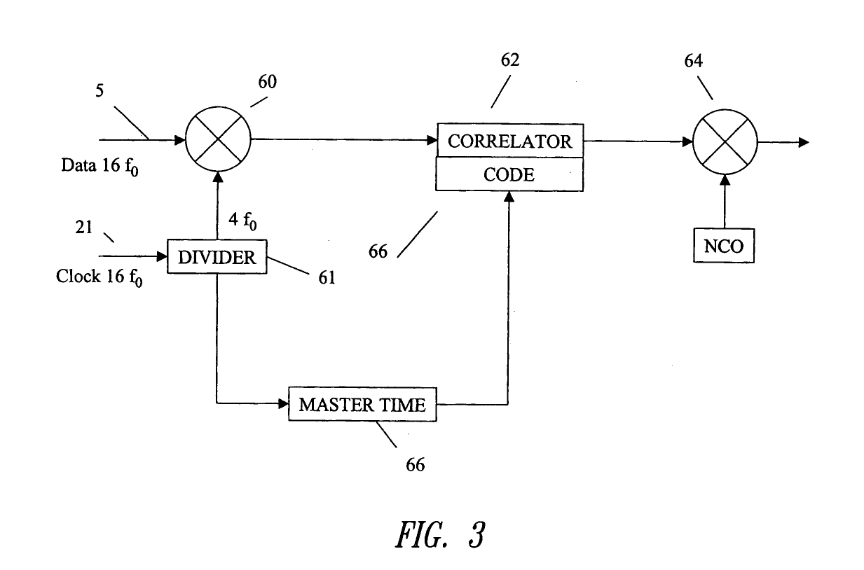

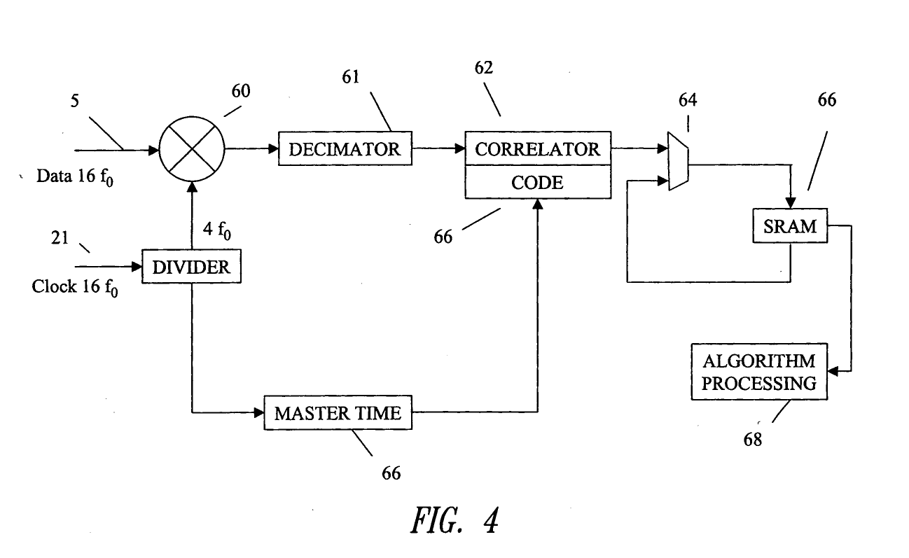

The main features of a GPS radio chip embodying the invention are shown in FIG. 2. The main features of a DSP for processing the received digitised signal are shown in FIGS. 3 and 4. Of importance is to note that the clock provided to the DSP on clock line 21 is derived from the same clock source 1 as the frequency for mixing in the radio chip.

The GPS radio chip will be described first as shown in FIG. 2. A received signal is first amplified in stages 3 and 17 and then mixed in mixer 7 with a frequency 1536 fₒ (where fₒ=1.023 MHz, the nominal frequency) to produces sum and difference signals, the difference being the carrier 1540 fₒ minus 1536 fₒ=4 fₒ. This signal is filtered using filter 2 of frequency 1575 MHz and bandwidth 20 MHz, and then digitised by sampling in ADC 4 at 16 MHz (in fact 16 fₒ=16.368 MHz) to produce a digital output of width 4 fₒ and sampling rate 16 fₒ. The digital signal is then provided to a DSP for acquisition or tracking.

The GPS radio chip uses a clock source 1 which could be any reference clock. For preference, though, when implemented in a mobile telephone, the clock source is the existing mobile telephone clock. A clock divider arrangement 10 is used to produce the clock signals required to mix the received RF signals and, significantly, the same divider arrangement 10 and hence clock source is used to provide the clock to the DSP on clock line 21. This provides clock coherence. It is noted, for ease of understanding that the term “coherence” is generally used to refer to coherence of integration (amplitude rather than power integration) and also to coherence of clocks. For simplicity, when coherence of clocks is mentioned, this will be referred to as clock coherence.

The divider arrangement 10, comprises a first divider 12 which divides by a factor R where R is preferably value R=2. A PFD 14 (phase frequency detector) keeps the signal in phase with a tank (tuned circuit) source 15. Dividers 16 (factor P where P is preferably P=5) and 18 (factor where N is preferably N=19) provide a loop back to PFD 14. A final divider 20 divides by a factor M and produces the digital clock to the DSP, where M is preferably M=96. This last division produces the clock output on clock line 21 of 16 fₒ. It is noted at this point that taking the clock for the DSP on line 21 from a source as close to the mixer 7 as possible improves the accuracy because the accuracy is in ppm of the clock at 1536 fₒ rather than at a division of this frequency.

The use of a single clock source for the radio and for the DSP ensures clock coherence between the incoming signal and the correlations performed with a local CA code generator in the DSP. This ensures that the rate of advance, in the time domain, of the correlations can be set to exactly match the incoming desired signal. Because it is derived from the local oscillator, setting the frequency automatically sets the rate of advance with absolute clock coherence.

The Doppler effect due to satellite motion previously mentioned can be ±4 to 5 KHz or so in 1575 MHz carrier. Accordingly, all the energy from all satellites will pass the band pass 2 in the radio chip which has bandwidth 20 MHz. However, as noted above, the clock coherence of the mixing frequency and DSP ensures that, for a given satellite Doppler shift, the correlations performed in the DSP remain in a given code bin over longer than usual integration periods. This is useful, for example, in the indoor environment with legacy GPS CA code signals, where there is the potential for signals at 50 dB C/No where they have passed directly through a window, or open side of a multi-storey car park, and also of signals at 20 dB C/No where they have suffered multiple reflections and passed through the fabric of the building.

However, the GPS signal structure only gives 20 to 22 dB of isolation between signals, so that if a receiver is designed for 15 dB C/No, without complex precautions, any unwanted satellite of (15+20=35 dB) could be falsely acquired, thus preventing the acquisition of the desired weak satellite.

On frequency cross-correlations are easily identified and rejected, but they still mask the desired signal and require a repeat acquisition. However, there are also off-frequency cross-correlation responses, most frequently at integer kilohertz offsets from the strong satellite signal. In both cases it is desirable to prevent the false acquisition rather than reject if afterwards.

Thus even if we have found one satellite successfully, there may be 7 more in the sky, and each may be found at any of 8 integer kilohertz offset locations in the search band i.e. 56 possible signals in the 8 KHz band, of which only 7 possibilities are real. The closeness of the 56 frequencies makes separation by frequency impractical and impossible where there is user Doppler shift, for example in a train or car in a tunnel.

So an alternative method is required to eliminate the roughly 50 false signals, and because of the time involved, it must ignore them, finding only true signals, rather than specifically find them to allow a repeat acquisition attempt.

The on-frequency cross-correlations are minimised by ramping up the sensitivity in steps, so that strong satellites are found first. Whilst not perfect due to changing signal strengths, this improves system resilience considerably. It is backed up by comparing each proposed acquisition candidate with all satellites already acquired, and where there is a precise frequency match, the candidate is rejected. The bulk of the problem is off-frequency cross correlation; i.e. we think we have found weak satellite 6 at 9 KHz, when it is really strong satellite 27 at 8 KHz.

To achieve high sensitivity, the integration period can be increased. This gathers the satellite energy for longer, while reducing the noise power received. However, a large part of the benefit is achieved using I,Q coherent integration, and this reduces the channel bandwidth (and hence noise). However, this means there are more frequency bins to search, resulting in an n-squared problem; increasing the integration time by ×N narrows the channel by ×N, thus the same time-frequency search space is covered in ×N² if there is no increase in parallelism.

Incoherent integration (ie power, rather than I,Q signals), has two benefits. It is not tripped up by data-bit edges, and it does not narrow the bandwidth of the channel.

However it is only by narrowing the channel that the SNR is improved, because all the signal energy is retained, but the thermal noise, which is spread evenly across all bandwidth, is more and more rejected.

There is some gain in incoherent integration, however, and that comes from the crest to mean ratio of the correlation response. The worst-case noise spikes are very large compared with the mean. As a result, adding together multiple correlation responses has the effect of bringing all the noise responses towards the mean, effectively eliminating the nasty spikes, while the correlation response of the signal remains the same on a normalized basis.

However the transition from coherent to incoherent is normally achieved by squaring, and this itself is a hazardous exercise. The worst-case noise samples grow disproportionately, because of the squaring.

The extent of this problem depends on the SNR. If there is a positive SNR, squaring does not cause excessive degradation. If there is a very negative SNR, then squaring is a disaster. We refer to the SNR at the point of squaring not at the antenna. Thus the ideal scenario is to perform as much coherent integration as is practical, then convert to incoherent and continue further, thus maximizing the benefits of both schemes.

The optimum balance varies with both the SNR, and the type of noise. Thus the solution we have adopted, while hardware implemented to allow fast clock rates and high degrees of parallelism, is still register-configured, to allow the software to choose the ideal balance.

In practice, incoherent integration can be achieved by methods other than squaring. The method used both achieves higher gain, though still less than fully coherent, and also allows the frequency information to be extracted after integration, which squaring does not allow.

We have appreciated that increasing the integration time in itself is only beneficial for separating the signal from noise. When the interfering signal is cross-correlation, further integration strengthens both wanted and unwanted signals. It is a question of the length of time of integration. However, this only occurs over a limited time period because the Doppler shift of one satellite is likely to differ in comparison to another. This means that over a desirable timescale, a given satellite will remain in the same frequency bin, but another for which cross-correlation is a problem will drift to a different frequency bin. Each frequency bin is a portion of the possible frequency range with the ±4 or 5 KHz Doppler range and the range of any other sources of frequency drift. Typically, there are 20 to 40 frequency bins to search for any given code, meaning that acquisition requires searching 2046 code positions and 20 or more frequency bins.

So for a given correlation, whether the correlation remains in the same frequency bin will depend upon whether the correlation with the local code and sampled received signal are locked so as to match the repetition of the actual signal, and this depends upon the relative frequency different of the satellite signal and local clock. To integrate over a long period, we must empirically synchronise not only frequency (Doppler) and time (code-phase), but also range-rate. This is mathematically derivable from the chosen search frequency, provided the architecture is coherent (all derived from one clock). The range rate is the rate of change of distance (range) between satellite and receiver. The range rate can be determined from the Doppler shift and hence relative speed of change of range.

The accuracy of range-rate required is such that all the energy from the satellite over the integration period falls in a single correlation bin. If correlation bins are 500 ns, we might expect 250 ns accuracy. If the correlation period is 100 milliseconds, we require an accuracy of 250 ns in 100 ms ie 2500 ns/s ie 2.5 ppm.

Similarly if the integration period was 1 second, an accuracy of 0.25 ppm would be required.

The channel bandwidth is much narrower than this, usually 1 KHz in traditional outdoor GPS, down to a few hundred Hz with long integration periods for indoor use.

Thus if the clock driving the sampling system is derived from the VCO at the front end of the radio chip, then the frequency of the LO (and hence signal) will always be exactly clock coherent with the sampled signal to match to the locally generated code, and the wanted signal will integrate optimally. All energy will remain in the same correlation bin for a given correlation

The reference clock for the baseband, in our example 16.368 MHz, is easily derived from the VCO/first LO simply by dividing by 96. Some part of the divider 10 may be shared with the divider driving the PLL shown as dividers 16, for power efficiency and silicon area saving. Note that 96 is an exceptionally favourable number, being 3×2⁵, with so many factors of two being very suitable for binary counters.

Thus if the radio synthesiser can be tuned in steps of 100 Hz, ie about 0.06 ppm, the coupled code generator/sampler would be sufficiently accurate for long integration times.

The digital signal processor part of the GPS radio embodying the invention is shown in FIG. 3, as used in a tracking mode. As previously explained, the data signal digitised at 16 fₒ and width 4 fₒ is transferred on data line 5 to the DSP. The clock at 16 fₒ derived coherently from clock source 1 is provided on line 21 and is divided by four in divider 61 to produce 4 fₒ for a first digital downconverter 60 such as an XOR arrangement.

The sampled signal at this point has width 4 fₒ±error ±Doppler. The use of a TCXO reduces the error value so that the signal can be considered to include Doppler error only.

The sampled and down converted signal is fed to correlator arrangement 62 which perform correlations with a local version of the relevant CA code. Various correlation arrangements are well known to those skilled in the art. Of note is that the clock supplied to the correlator arrangement is derived from a master time source 66 which receives the clock signal on line 21 which has been coherently derived from the single clock source 1.

The DSP as used in an acquisition mode is shown in FIG. 4 and comprises the same functional items as FIG. 3. A correlation arrangement of correlator 62 and local code source 66 is arranged to correlate the received digitized signal with a local version of the CA code. Notably, the clock source for correlations is the same as the clock source used to derive the mixing signal in the radio chip and so is clock coherent. A decimator 61 is used in acquisition mode to increase correlation speed by reducing the number of samples. The results of successive integrations are provided to SRAM 66 which stores the results for processing. An algorithm processing unit 68 then processes the integration results to determine the correct code phase for acquisition. This algorithm processing could be in software or hardware and involves summing and comparison steps, the hardware implementation of which is known to the skilled person.

The algorithm processing involves taking two (or more) integrations and combining them in such a way as to eliminate integration results which have been produced from off frequency cross correlation satellites. This is achieved by having a separation period between integrations. To separate the cross-correlation from the true signal we need a sufficient time that the unwanted signal drifts out of the correlation bin.

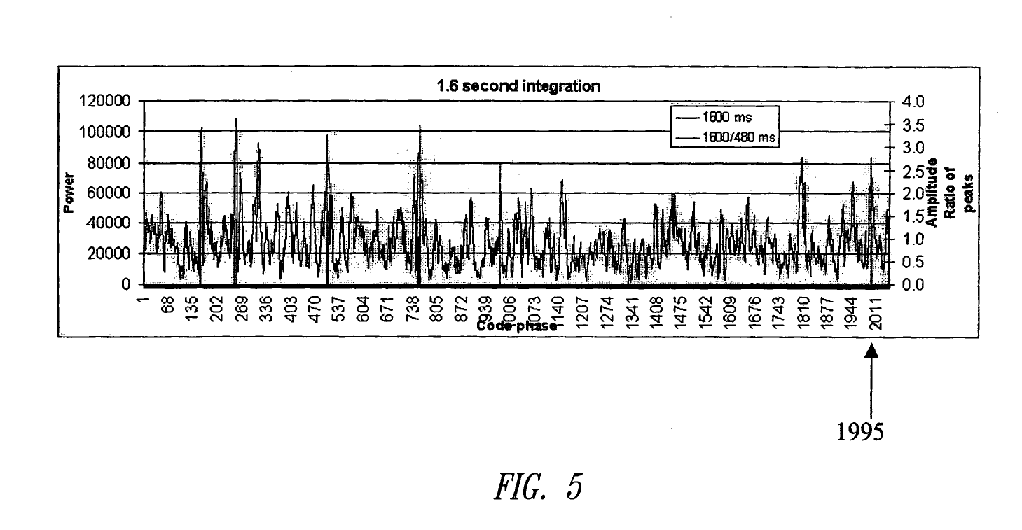

An example correlation s shown in FIG. 5 which shows the correlation results for an example 1.6 seconds of integration, performed as 100 incoherent blocks of 16 ms, each performed coherently, while tracking the code-phase open-loop. With the knowledge from post-processing, that the true satellite is at code bin offset 1995, with amplitude around 85000, it is clear that we have failed, because there are 6 other correlation peaks of greater amplitude.

However for off-frequency cross correlations, the usual coherent mathematics of 1540 carrier cycles per code chip fails. As a result a fully clock coherent receiver (all frequency and time measurements derived from a single crystal, single NCO) the embodiment can separate real signals from fakes. It simply integrates frequency to measure time. And on the cross correlation, this fails. Thus a correctly tracked signal, using open loop tracking, continues to put all the signal energy in the same correlation bin, but the off-frequency cross-correlation from another satellite fails to advance at the correct rate, so the tracking correction is wrong, and its energy is spread over more than one correlation bin, losing gain.

If the off-frequency error is 1 KHz, this is 0.6 ppm, so with 2046 correlation bins, the time error is one bin slip every 0.8 seconds, and proportionately larger for higher frequency errors.

Thus there is 3 dB (wanted to unwanted) signal gain for approximately one second of integration, providing the receiver is actively open-loop tracking the code during integration.

This is however, not enough in a short term. The conventional approach, integrate until the signal energy is the highest of all correlation bins, would take too long. The gain is linear, not logarithmic, so the gain over 5 seconds would not be 3+3+3+3+3=15 dB. In 5 seconds the cross-correlation energy would be spread over about 6 bins, while the true signal remained in just one, ie a linear gain of 6, ie 8 dB.

This is useful, while the 20 dB cross-correlation isolation is often breached, 28 dB is very rare.

The correlation response is a triangle, 2 microseconds wide. Thus at 1 ppm separation between satellites, it would take approximately 2 seconds to cross the correlation bin, and would yield a 3 dB additional benefit as the average of the triangle is half the peak, and the wanted signal would effectively be always the peak (subject to static bin mis-alignment).

However there is no benefit in integrating for 2 seconds. If too much of this was coherent, the channel bandwidth would be prohibitively narrow. Conversely, if little was coherent, there would be too much incoherent integration, which is less beneficial always, and yields diminishing returns over longer periods, as much of its benefit relates to the statistical gain resulting from the high peak-to-mean ratio for noise correlation.

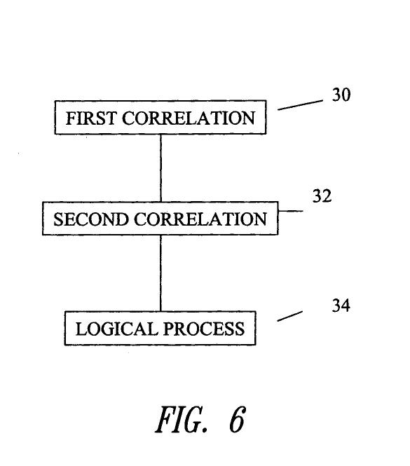

The process undertaken by algorithm processing embodying the invention is shown broadly in FIG. 6. The process could be operated in hardware, but is chosen to be implemented in software to combine the results of hardware correlations. The first step 30 is to integrate at a given frequency setting of the divider 10 for a first time period of, for example, 64 or 100 milliseconds. This can be divided between coherent and incoherent integration (the description of which is known to the skilled person and need not be described here).

At a second step 32, the integration is repeated at the same frequency setting and at a period later of, for example, two seconds. The chosen gap or delay of this time period is such that an unwanted satellite is likely to have crossed from one correlation bin to another as shown mathematically above.

At a third step 34, the two sets of correlation results are logically processed using a selection algorithm by which the correct code position is selected, ignoring unwanted cross-correlations. As previously noted, this algorithm could be performed in hardware or software. If performed in software, then the 2046 results of each correlation are stored in memory for analysis. It may be more efficient to add hardware that performs the algorithm on the fly while the data is being gathered. Then only one bit of storage is required for each bit, or a small list of candidates.

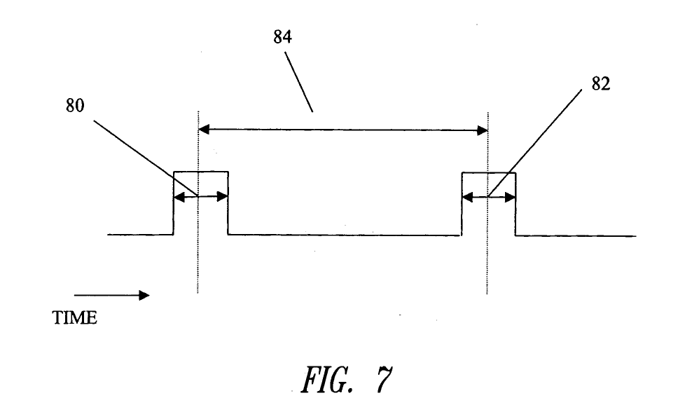

The time periods involved are explained with reference to FIG. 7. A first integration period 80 is performed of the order milliseconds. A separation period 84 of the order one second then elapses before a second integration period 82 is performed.

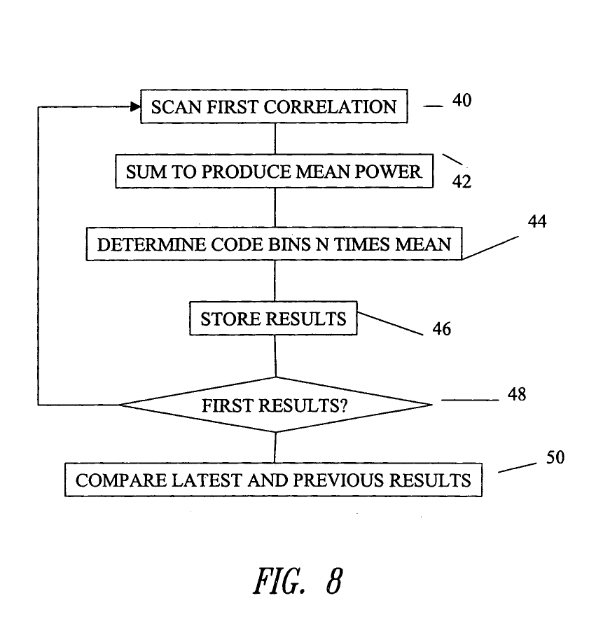

An example algorithm is given below and is shown in greater detail in FIG. 8. The steps are as follows:
1) Scan first set of 2046 results 40 and calculate mean power at step 42.
2) Mark all code position bins that are peaks (higher than both neighbours) and exceed N×mean (where N is programmable) at step 44 and store the results at step 46.
3) Repeat (1) and (2) for second set of correlation results at steps 40, 42, 44, and 48.
4) Find the code position bins that are marked in both passes at step 50. With suitable selection of the value N, there will be only one result. N is a non-integer value, found to be typically between 2 and 4.

The factor N is chosen in the light of existing interference environment such that the likelihood of false acquisition is low. The factor may be different for the first integration period and second integration periods particularly if the two integration periods differ. The factor N may be predefined, but is preferably derivable in software and stored in a register. To calculate an appropriate value of N, the number of integrations of amplitude N times the mean divided by the total number of code bins is chosen to be say 5 percent.

The hardware has been idle for the intervening period of almost 2 seconds and this time can be used to search for all the other satellites if required. However in this case, the first pass results must not be overwritten, ie must be retained in the CPU/software, or additional hardware memory provided.

The combination at step 4 of the algorithm may be logical, ie a candidate is active in both results, or it may be both logical and arithmetic.

The logical arrangement is chosen when the factors are set so that fewer than ten candidates remain in each set. There is then 10*10/2046, ie about 5% chance of a false acquisition. Such a problem would be immediately detected and rejected, so 5% is considered acceptable.

The arithmetic approach is chosen when the thresholds are set to allow large numbers of candidates, say 100 in each period. There will then be multiple successful results in the combined result, so the largest is chosen.

A comparison of the two approaches shows little benefit in the arithmetic approach, except where the initial integration period was too short. There are also benefits in the logical approach that it can more easily be implemented in hardware, saving storage and I/O bandwidth for the processor.

The algorithm adopted adds logic to the acquisition algorithm, not simply integration.

As demonstrated above, at least one second is required to cause a time error of one bin or more. In simple integration, this is smearing of the response, sharp peaks become smooth-topped hills.

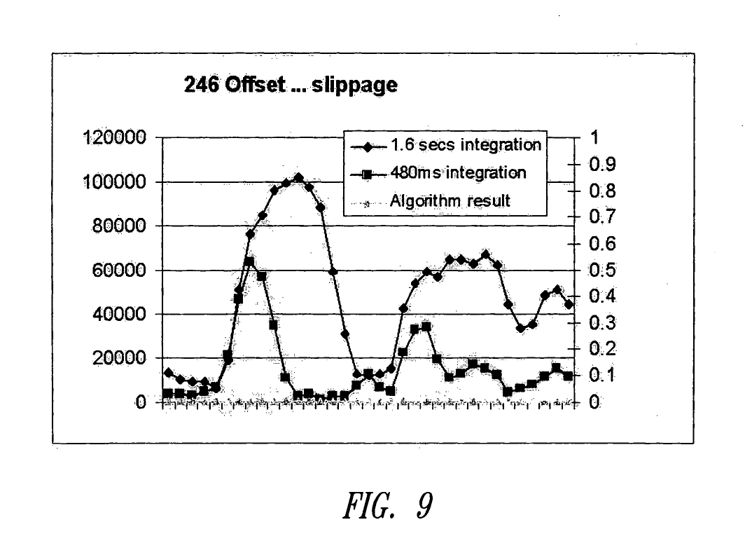

As shown in FIG. 9, the same signal integrated for 480 milliseconds (squares), is a sharp peak, but after 1.6 seconds of integration, has a rounded or flat top. Note also that the diamond peak is to the right of the square peak, not over it, indicating that it is derived from an off-frequency correlation that does not comply with the clock-coherency rules. Using the algorithm described, the correct result is identified. Note that both the viable and local peak rules are required, and give great benefit with the datasets shown.

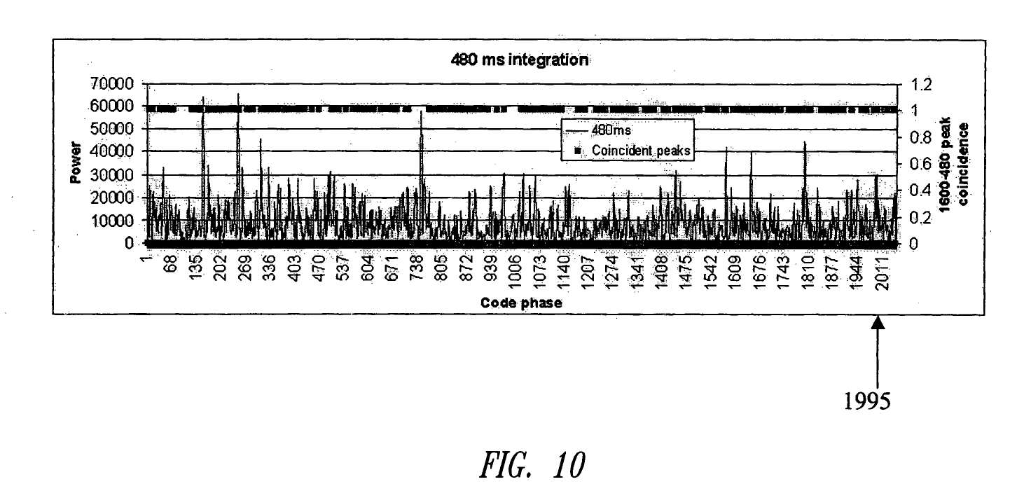

FIG. 10, shows the test with the local peaks test omitted, there are some 6 successful results, so the correlation fails as the correct one (at 1995) is NOT the largest. Also shown in FIG. 10 is the result of just marking coincident local peaks, which shows that this rule alone is not satisfactory.

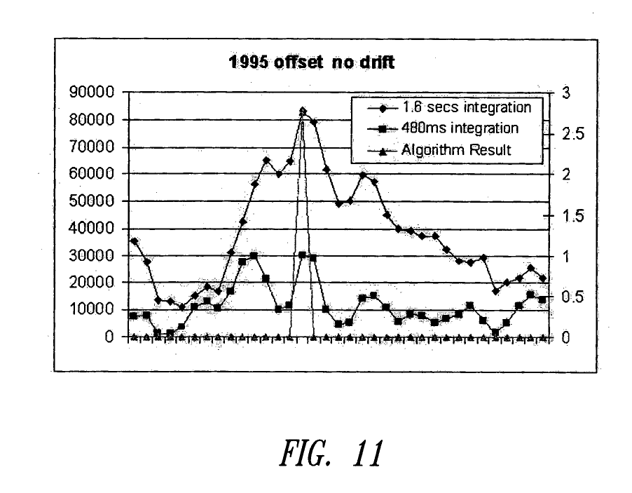

However FIG. 11 shows the combined test functioning correctly, with a single successful result, rejecting the cross-correlation, and selecting the true signal.

This result was carefully tuned in terms of viability thresholds, and it can be seen that a minor reduction of the selected point in either the diamond plot or the square plot would have made it no longer a local peak. This is because with 2046 correlation bins, energy can appear in two adjacent bins. Thus the final algorithm has been improved to allow two points on each crest to be considered as local peaks. Note referring to the diamond plot on FIG. 9, that the effect of the long correlation on cross-correlations is to yield a wide rounded peak, where the energy is in the width of the hill rather than the height. Had this been a real signal, we would have expected the height to grow by a factor of three, commensurate with the integration time ratio. In FIG. 11, we see the expected factor of three.

There is no requirement for two overlapped integration times, or times of different lengths. This was used for the experiment to demonstrate the relationships between different types of integration and detection using identical data.

The preferred method is two shorter periods, separated by between 1 and 2 seconds. This allows the hardware to be re-used by other satellites in the intervening period.

Note that only the first satellite is difficult, so often subsequent satellites will not use the acquisition engine but be directly acquired in the tracking channels. However if the main VCO and reference clock are being adjusted for subsequent satellites, there are side effects in two areas.
1) The tracking channels will be seriously handicapped by the varying reference clock, both in frequency and time domains.
2) Handover from acquisition to tracking will be completed to generate correct predictions.

The process only needs to tune the VCO by +/−4 ppm, and only for a 2 second period. Thus time ambiguity could be some 8 microseconds out, probably within the locking range of the tracking channel. However frequency ambiguity of +/−6 KHz is definitely not manageable by the narrow band channel, so either the channel NCO will have to be pre-corrected, or no tracking attempted until after all the satellites have been acquired. The ideal route is decided by the ultimate sensitivity required. Usually only one satellite will be acquired using the acquisition engine, so once this is done, tracking can start and the VCO is not retuned. In exceptionally weak signal cases it will be necessary to do all satellites in the acquisition engine, and maintain a log of the tuning values applied, so that on tracking start, corrected estimates of code-phase can be applied, after the VCO frequency has been returned to its nominal value.

As shown above, 2 seconds integration only increases the satellite separation by 3 dB. However two separate results separated by 2 seconds give a much bigger improvement.

The reason for this is the peak to mean ratio of the correlation plots. The wanted signal may be number 10 in amplitude sequence in each plot, but the chances of any one of the nine unwanted ones appearing on both plots is very low, 9 times 10=90/2046, ie about 5 percent. Thus if the value N×peak is chosen at this level, there will be only 5 percent mis-acquires, which will be rapidly rejected as untraceable.

Thus even if the cross-correlation is 10 dB above the wanted signal, it will fall in different frequency bins in the two tests and thus be deleted.

In summary, we have appreciated that the ideal integration period is less than 100 milliseconds, but we need much longer to allow the two signals to drift apart in the time domain. If we need them 2 microseconds apart, and have 1 KHz Doppler shift=0.66 ppm, we need to wait 1.33 seconds. Thus, the acquisition process performed integrations over an integration period of the order of 100 milliseconds and performs one or more subsequent integrations a time period of the order 2 seconds apart (preferably around 1.33 seconds), being the timescale over which integration of a code from an unwanted satellite crosses to a different frequency bin.

The three key steps are:

1) Deriving the code generator clock directly from the radio receiver L-band local oscillator, which can be turned in very small steps. The small steps mean that the rate of advance, in the time domain, of the code generator can be set to exactly match the incoming desired signal. Because it is derived directly from the LO, setting the frequency automatically sets the rate of advance with absolute coherence.
2) In the software, take two integration periods widely separated (order 1 second separation). The two sets of results will agree for the desired signal, disagree for the cross-correlation.
3) Combine the two sets of results. Simple addition only gains three dB. Prequalifying each set of candidates before combination yields a much better response.

For example, a candidate may need to be above a fixed threshold, above an adaptive threshold, a local peak (ie higher than its neighbours), or any combination of the above. Reducing each list from 2046 to say 10, then logically combining the two lists, not adding, gives excellent results.

Although two integration periods are discussed, it is of course possible to undertake multiple integrations separated by separation periods and to combine the results. However, in the preferred embodiment of GPS signal acquisition, time is a premium and so the choice of two integrations separated by a single gap is preferred.

1. A method of acquiring a received broadcast signal of the type having a repeated code to distinguish the signal from other codes broadcast at substantially the same frequency but having small differences due to frequency shifts, comprising:
mixing the received broadcast signal with a local frequency derived from a master clock source;
digitizing the received broadcast signal to produce a received digitized signal;
correlating the received digitised signal with a local version of the repeated code using a clock derived coherently from the master clock source for a first time period to produce a first result;
correlating the received digitised signal with a local version of the repeated code using the clock derived coherently from the master clock source for a second time period separated from the first time period by a separation period to produce a second result; and
combining the first and second correlation results by comparing the location of correlation peaks to reject peaks not appearing at the same position in both the first and second correlation results to thereby acquire the broadcast signal.

2. A method according to claim 1, wherein an integration peak is one for which the amplitude is N times the mean correlation amplitude.

3. A method according to claim 2, wherein N is in the range 2 to 4.

4. A method according to claim 2 or 3, wherein the value N is selected so that, for a given correlation around 10 correlation positions have amplitudes N times the mean.

5. A method according to any preceding claim, wherein a correlation peak is one for which the neighboring code positions are lower.

6. A method according to any preceding claim, wherein a correlation peak is one for which the first and second correlation results are derived from a signal at the same frequency.

7. A method according to any preceding claim, wherein if there is more than one possible correlation peak, the larger peak is selected.

8. A method according to any preceding claim, wherein the first and second integration periods are of the order 100 ms.

9. A method according to any preceding claim, wherein the separation period is of the order one second.

10. A method according to any preceding claim, wherein the separation period is chosen such that the other codes broadcast at substantially the same frequency produce integrations at different relative positions in the first and second integrations due to the frequency shifts.

11. A method according to any preceding claim, wherein the signal is a GPS signal.

12. A system arranged to acquire a received broadcast signal, of the type having a repeated code, to distinguish the signal from other codes broadcast at substantially the same frequency but having small differences due to frequency shifts, the circuit comprising:
a clock divider arranged to receive a master clock signal and to produce a mixing frequency for mixing with the received broadcast signal to reproduce a mixed down signal and a correlation clock;
a correlator arrangement arranged to receive the digitised signal and the correlation clock and to correlate the received digitised signal with a stored copy of the repeated code for at least two integration periods separated by a separation period;
a store arranged to store the results of the correlations; and
a comparator arranged to compare the results of the at least two correlations by comparing the location of integration peaks to reject peaks not appearing at the same position in the results of the at least two integrations.

13. A system according to claim 12, wherein the first and second correlation periods are of the order 100 ms.

14. A system according to claim 12 or 13, wherein the separation period is of the order 1 second.

15. A system according to claim 12, 13 or 14, wherein the separation period is chosen such that the other codes broadcast at substantially the same frequency produce correlations at different relative positions in the first and second correlations due to the frequency shifts.

16. A system according to any of claims 12 to 15, wherein the system further comprises a mean derivation unit arranged to derive a mean value of the results of the integrations, the comparator being arranged to determine which relative code positions have peaks with values greater than NX the mean value and to select those peaks appearing at the same position in the first and second integrations.

17. A system according to claim 16, wherein N is a non-integer value between 2 and 4.

18. A system according to any of claims 12 to 17, wherein system is a semiconductor integrated circuit.

19. A GPS receiver comprising the system of any of claims 12 to 18.
